(19) United States
(12) Patent Application Publication
(10) Pub. No.: US 2023/0406538 A1
(43) Pub. Date: Dec. 21, 2023

(54) DEVICE AND SYSTEM FOR RELEASING, MAINTAINING IN FLIGHT AND RECOVERING A TETHERED AEROSTAT

(71) Applicant: CNIM SYSTÈMES INDUSTRIELS, La Seyne-sur-Mer (FR)

(72) Inventors: Bernard Dabezies, Toulon (FR); Laurent Gruchet, Toulon (FR)

(21) Appl. No.: 18/034,262

(22) PCT Filed: Nov. 2, 2021
(86) PCT No.: PCT/FR2021/051919

§ 371 Date: Apr. 27, 2023

(30) Foreign Application Priority Data
Nov. 3, 2020 (FR) FR2011246

(51) Int. Cl. B64F 1/14

(52) U.S. Cl. CPC B64F 1/14

(57) ABSTRACT

The invention mainly relates to a device for automatically releasing, maintaining in flight, and recovering a tethered aerostat. The device includes a platform having a rotatably mobile part, a device for recovering the tethered balloon secured to the mobile part, and at least first and second winches. A first cable called umbilical cable is connected to the first winch and has an end provided to be secured to the aerostat. A second cable called sling is divided into at least an adapted mooring portion having an end provided to be secured to aerostat, and a connecting portion connected to the second winch, which connecting portion has a linear mass smaller than or equal to seven grams per meter and a length greater than that of the mooring portion.

### TECHNICAL FIELD

The invention pertains to the field of aeronautics.

The invention more particularly falls within the framework of the automated recovery of a tethered aerostat, or tethered balloon, such aerostats being connected to a ground platform by at least one cable called umbilical cable.

### BACKGROUND

These aerostats are kept at an altitude controlled by the balloonist, for various applications ranging from tourist attraction to a weather and air quality measurement station.

Certain aerostats are tapered balloons to improve their stability and which, due to their shape, are submitted to aerodynamic forces which need to be taken into account in the recovery of the aerostat, and in particular the weathervane effect which causes the rotation of the aerostat around an axis perpendicular to the axis of said aerostat, called yaw axis. In particular, during the recovery of the aerostat and in anticipation of its mooring in a cradle secured to the platform, it is necessary to ascertain that the axis of the balloon is aligned with that of the cradle and of the platform.

However, the operation of alignment of the aerostat during its mooring requires the intervention of several people, each managing a mooring line secured to the aerostat and provided to moor it to the platform. This operation is thus costly in time and in staff.

### SUMMARY OF THE DISCLOSURE

The invention thus aims at providing a device and a system for releasing, maintaining in flight, and recovering an aerostat simpler and less expensive to implement.

For this purpose, the invention aims at a device for releasing, maintaining in flight, and recovering a tethered aerostat, comprising:

a platform comprising a fixed part provided to be placed on the ground, a rotatably mobile part which extends along a longitudinal axis and which is connected to the fixed part by rotary drive means, a recovery device called cradle secured to the mobile part and provided to receive an aerostat, and at least first and second cable winding devices called first and second winches;

control and command means configured to drive the rotary drive means and the first and second winches;

a first cable called umbilical cable connected to the first winch and having an end provided to be secured to the aerostat, the umbilical cable being adapted to withstanding the tension exerted by the aerostat, and

a second cable called sling divided into at least a mooring portion adapted to withstanding the tension exerted by the aerostat and having an end provided to be secured to the aerostat, and a connecting portion connected to the second winch, which connecting portion has a linear mass smaller than or equal to seven grams per meter and a length greater than that of the mooring portion.

The device may also comprise the following optional characteristics considered in isolated fashion or according to all possible technical combinations:
The rotary drive means are motorized and driven via the control and command

means.
The rotary drive means comprise an electric motor secured to the fixed part of the platform, at least one mobile pinion adapted to being driven by the motor and a crown secured to the mobile part of the platform and cooperating with the pinion, the pinion/crown assembly being arranged to allow a free rotation of the mobile part of the platform with respect to its fixed part.
The first winch comprises at least one drum arranged at a distance from the rotation axis of the mobile part of the platform.
The first winch comprises at least a deflection pulley arranged on the longitudinal axis of the mobile part of the platform, which deflection pulley is mobile along the longitudinal axis of said mobile part.
The rotary drive means comprise at least one means for assisting the rotation of the mobile part of the platform, which assistance means comprise at least one torque sensor connected to the control and command means and configured to detect the torque exerted by the umbilical cable against said sensor and to trigger the motor of the rotary drive means as soon as the detected torque exceeds a determined threshold value.
The device comprises two traction sensors connected to the control and command and configured to measure the tractions respectively of the umbilical cable and of the mooring portion of the sling.
The umbilical cable and the mooring portion of the sling have a resistance to traction greater than or equal to 11.5 tons.

The invention also aims at a system for automatically releasing, maintaining in flight, and recovering a tethered aerostat comprising:
an aerostat;
a platform comprising a fixed part intended to be placed on the ground, a rotatably mobile part connected to the fixed part by rotary drive means, a recovery device called cradle secured to the mobile part and provided to receive the aerostat, and at least first and second cable winding devices called first and second winches;
control and command means configured to drive the rotary driving means and the first and second winches;
a first cable called umbilical cable connected to the first winch and having an end secured to the aerostat, the umbilical cable being adapted to withstanding the tension exerted by the aerostat, and
a second cable called sling divided into at least a mooring portion adapted to withstanding the tension exerted by the aerostat and having an end secured to the aerostat, the respective ends of the umbilical cable and of the mooring portion of the sling being aligned along an axis of the tethered balloon, and a connecting portion connected to the second winch, which connecting portion has a linear mass smaller than or equal to seven grams per meter and a length greater than that of the mooring portion.

The system may also comprise the following optional characteristics considered in isolated fashion or according to all possible technical combinations:

The sling is secured to the nose of the aerostat, which aerostat has a tapered shape.

The system comprises two traction sensors configured to measure the tractions respectively of the umbilical cable and of the mooring portion of the sling.

### BRIEF DESCRIPTION OF THE FIGURES

Other features and advantages of the present invention will clearly appear from the description which is given thereof hereafter, as an indication and by no means limiting, in connection with the accompanying drawings:

FIG. 1 shows the system for releasing, maintaining in flight, and recovering a tethered aerostat according to the invention, which aerostat is connected to a platform by an umbilical cable and a sling;

FIG. 2 shows the different phases of flight and of mooring of the tethered aerostat to the platform of the system of the invention;

FIG. 3a shows the system of FIG. 1 with a first winch in a first position;

FIG. 3b shows the system of FIG. 1 with the first winch in a second position; FIG. 4a shows a sling of the invention according to a first variant;

FIG. 4b shows a sling of the invention according to a second variant;

FIG. 4c shows a sling of the invention according to a third variant;

FIG. 5 shows a sensor of the torque exerted by the umbilical cable connecting the aerostat to the platform.

It is first specified that in the drawings, the same reference numerals designate the same elements whatever the drawing where they appear and whatever the way in which these elements are represented. Similarly, if elements are not specifically referenced in one of the drawings, their reference numerals may be easily found by referring to another drawing.

It is also specified that the drawings essentially show an embodiment of the object of the invention but that there may exist other embodiments which comply with the definition of the invention.

### DETAILED DESCRIPTION

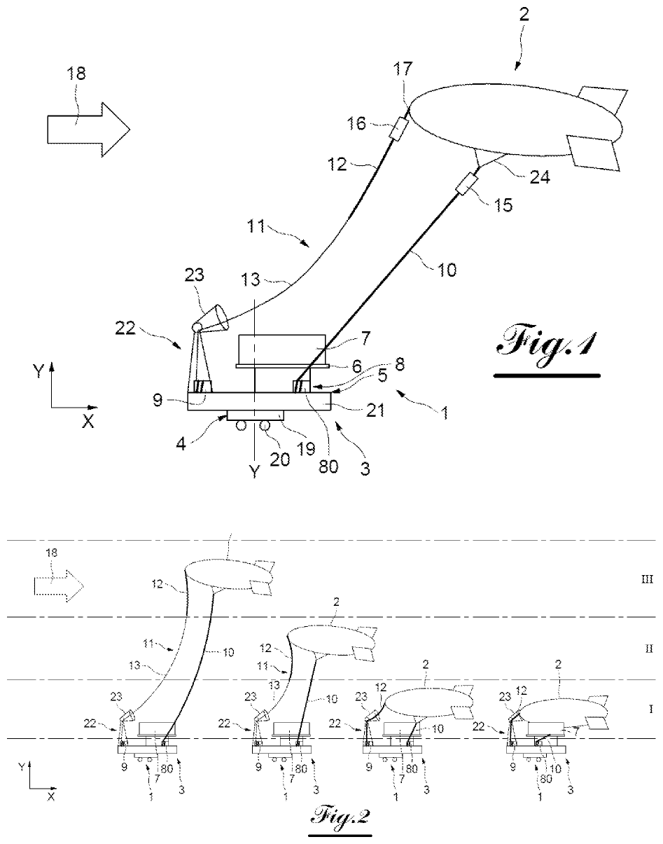

Referring to FIGS. 1 to 3b, the invention concerns a device 1 for releasing, maintaining in flight, recovering, and mooring a tethered aerostat 2 called tethered balloon in the rest of the description. The assembly comprising this device 1 and tethered aerostat 2 forms a system for releasing, maintaining in flight, recovering, and mooring according to the invention.

Tethered balloon 2 is of known type and has a flexible envelope inflatable with a gas lighter than air, in particular helium. This balloon 2 advantageously has a tapered shape to limit aerodynamic stress. Further, balloon 2 orients according to the direction of wind 18. Tethered balloon 2 comprises a plurality of onboard measurement devices such as cameras, radars, various probes, these onboard devices being arranged in frames (not shown) secured to the envelope.

Balloon 2 being tethered, it is constantly connected to a platform 3 on the ground forming part of the device 1 of the invention.

Referring to FIG. 1, platform 3 comprises a fixed part 4 placed on the ground 5 rotatable around an axis Y and which extends along a longitudinal axis X perpendicular to rotation axis Y. Typically, axis Y is vertically oriented.

Fixed part 3 is equipped with a frame 19 allowing the transport of equipment, as well as with wheels 20 enabling it to be displaced by means of a motorized vehicle, particularly a conventional tractor. Fixed part 4 further comprises means for locking wheels 20 to ensure the immobility of fixed part 4 with respect to ground, and retractable legs.

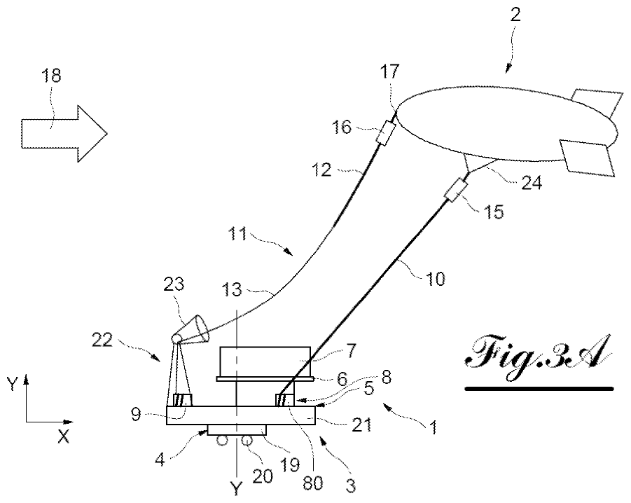

Mobile part 5, called boom in the rest of the description, comprises a frame 21 rotatable on the frame 19 of fixed part 4, and is equipped with a cradle 7 for receiving tethered balloon 2 for its mooring to platform 3, which cradle 7 is arranged on a structure 6 secured to mobile frame 21. Platform 3 also comprises a first telescopic arm 22 oriented along a direction parallel to axis Y, and having its free end part formed by a front crown 23 for receiving the nose 17 of tethered balloon 2, as shown in FIGS. 1 and 2. Platform 3 further comprises at least another and preferably two other telescopic arms (not shown) oriented perpendicularly to axis Y and ensuring the positioning of horizontal mooring lines on the tethered balloon 2 housed in cradle 7.

The fixed and mobile parts 4, 5 of platform 3 are connected together by means of an assembly formed by at least one pinion connected to fixed part 4 and a crown connected to the frame 21 of boom 5 and cooperating with the pinion. The pinion is further connected to a driving motor (not shown) secured to the frame 19 of the fixed part 4 of platform 3, the pinion, the crown, and the motor forming means for driving boom 5. Particularly advantageously, the axis of the motor freely rotates when it is not powered to allow the free rotation of boom 5 with respect to fixed part 4. Finally, the motor is driven by control and command means installed on platform 3. Of course, any other known rotary drive means may be adapted to platform 3 without departing from the framework of the invention.

Tethered balloon 2 is connected to the platform by a first cable called umbilical cable This cable is connected in the vicinity of the center of balloon 2 via plurality of lines 24, and to platform 3 via first motorized winding means 8, typically a winch comprising at least one drum around which umbilical cable 10 may wind or unwind. This umbilical cable 10 is provided to resist the traction stress generated by balloon 2 submitted to wind 18. Typically, the resistance of umbilical cable 10 is in the order of from 10 to 15 tons, preferably around 12 tons, and is in all cases sufficient to avoid its rupture when it is submitted to the tension forces generated by balloon 2 in flight. Of course, the resistance of umbilical cable 10 is adapted to the size of tethered balloon 2. Finally, this umbilical cable 10 is sufficiently long to allow the flight of tethered balloon 2 at significant heights, typically higher than 1,000 meters.

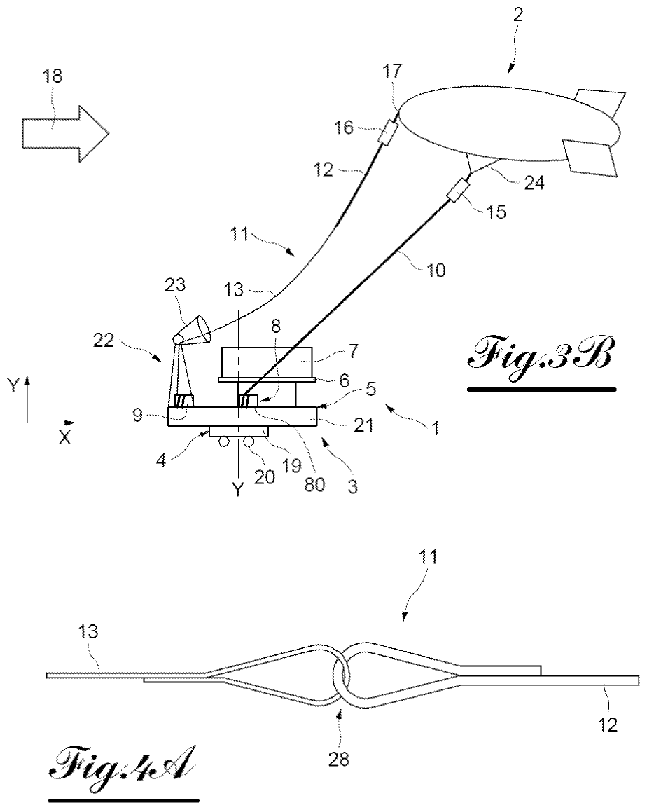

First winch 8 is connected to the frame 21 of boom 5 and comprises a drum ensuring the winding and the unwinding of umbilical cable 10. Further, first winch 8 comprises a pulley 80 for deflecting umbilical cable 10, which pulley 80 is mobile in translation along the longitudinal axis X, via a motorized displacement device, between a first so-called flight position shown in FIG. 3a where pulley 80 is distant from the Y rotation axis of boom 5, and a second so-called mooring position where pulley 80 is close to the Y rotation axis, to place the nose 17 of tethered balloon 2 in contact bearing against the front crown 23 of telescopic arm 22 when said tethered balloon 2 is moored to cradle 7. Further, deflection pulley 80 is arranged on the X longitudinal axis of boom 5.

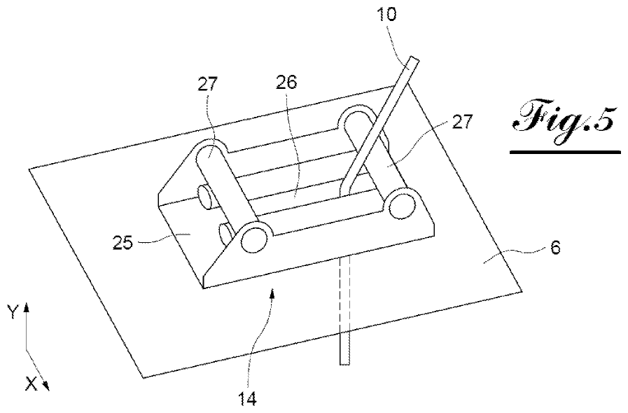

Referring to FIG. 5, the platform comprises means for assisting the rotation of boom with respect to the fixed part 4 of platform 3. These assistance means comprise a torque sensor 14 enabling to determine the lateral tension exerted by umbilical cable 10 when tethered balloon 2 is in flight. By lateral tension, there is meant the force exerted by umbilical cable 10 along a direction perpendicular to the Y rotation axis and to the X longitudinal axis. In other words, it is the horizontal force perpendicular to the X longitudinal axis of boom 5.

This torque sensor 14 comprises a frame 25 having a planar base secured to the structure 6 of boom 5 and pierced to allow the passage of umbilical cable 10. Structure 6 also comprises a through hole in front of the bore 26 of the frame 25 of torque sensor 14, to allow the passage of umbilical frame 10 towards first winch 8.

The sensor comprises two spaced-apart rollers 27 parallel to each other, secured to the frame 25 of sensor 14 and oriented along the longitudinal axis X of boom 5. These rollers 27 and the sensitive elements of torque sensor 14 are capable of detecting the lateral forces exerted by umbilical cable 10. They are actually connected to the control and command means of the device 1 of the invention. Each roller 27 of torque sensor 14 is configured to continuously measure the lateral force exerted by umbilical cable 10. Further, as soon as this lateral force exceeds a predetermined threshold recorded in a memory space of the control and command means, the latter send a signal to the rotary drive motor to command an assisted rotation of boom 5 in the direction of application of the lateral force.

This assisted rotation of boom 5 aims at aligning umbilical cable 10 with the longitudinal axis X of said boom 5, and thus avoid for tethered balloon 2 to be too offset with respect to platform 3.

Platform 3 also comprises a second cable 11 called “sling” in the rest of the description. This sling 11 comprises a mooring portion 12 provided to withstand the stress exerted by tethered balloon 2 and having its end connected to said balloon 2 at a distance from umbilical cable 10. In particular, mooring portion 12 is connected to the nose 17 of tethered balloon 2. Thus, and when tethered balloon 2 is in flight, the respective free ends of umbilical cable 10 and of the mooring portion 12 of sling 11 are aligned on the longitudinal axis of tethered balloon 2. This mooring portion 12 has structural characteristics identical to those of umbilical cable 10, that is, it has a resistance to traction in the range from 10 to 15 tons, preferably in the order of 12 tons. The length of this mooring portion 12 is shorter than 100 meters, preferably in the range from 30 to 40 meters.

According to the invention, sling 11 comprises a second portion called connecting portion 13 connected to platform 3 by means of a second motorized winch 9 formed inside of the frame of vertical telescopic arm 22, which connecting portion 13 crosses said frame and the front crown 23 of telescopic arm 22. The sling 11 of the invention is provided to remain secured to platform 3 and to tethered balloon 2. Also, the length of connecting portion 13 must be sufficient to allow the flight of tethered balloon 2, and is typically greater than 1,000 meters.

To limit the weight in flight of balloon 2 and of the two cables 10, 11, the connecting portion 13 of sling 11 has a much thinner cross-section than mooring portion 12, and has a linear mass smaller than or equal to 7 grams per meter. It is thus needless to modify tethered balloon 2 despite the presence of a second cable 11 hung to platform 3 during flight phases of tethered balloon 2. The different phases of tethered balloon 2 will further be described hereafter in reference with a mooring method according to the invention.

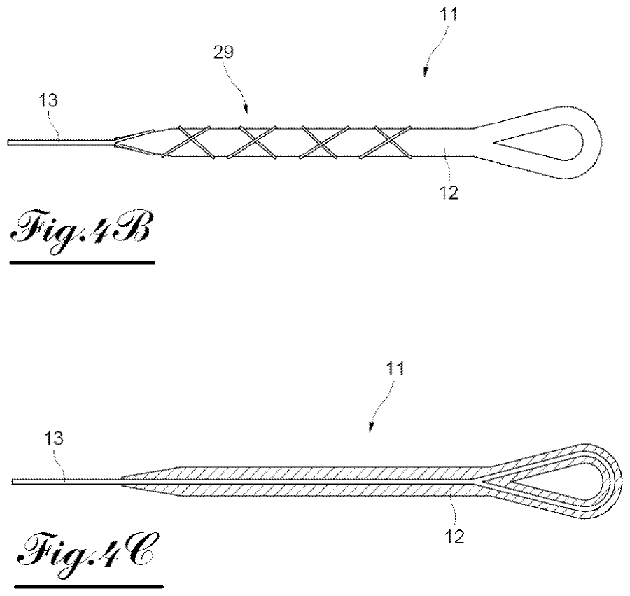

The coupling between the two portions 12, 13 of sling 11 may be performed in different ways. It may simply be a flexible coupling 28 (FIG. 4a), an interlacing of the two cable portions 12, 13 forming a splice 29 (FIG. 4b), or also an insertion of connecting portion 13 in a hollow part formed in mooring portion 12 (FIG. 4c).

Finally, and referring to FIG. 1, device 1 comprises two traction sensors 15, 16 connected to and driven by the control and command means. Traction sensors 15, 16 are respectively integrated at the level of umbilical cable 10 and of the mooring portion 12 of sling 11, and enable to measure and control the tension exerted by tethered balloon 2 on the first and second winches 8, 9. The function of these traction sensors 15, 16 will be specified hereafter in relation with the mooring method according to the invention.

Thus, the device 1 for releasing, maintaining in flight, recovering, and mooring of the invention comprises platform 3, winches 8, 9, umbilical cable 10, sling 11, traction sensors 15, 16, torque sensor 14, the rotary drive means of boom 5, and the control and command means.

Referring to FIG. 2, a method of mooring tethered balloon 2 will now be described. FIG. 2 further shows the different phases occupied by tethered balloon 2 during the implementation of the method.

Prior to the implementation of the method, balloon 2 is located in area III of FIG. 2, tethered balloon 2 is said to be in flight phase. It is located at a stationary altitude higher than 1,000 meters, and is in position to carry out is its planned missions (for example, survey of the quality of air) by means of the onboard devices. The altitude of tethered balloon 2 is known at each time for example by means of an altimeter secured to balloon 2. Further, the control and command means increment a counter at each revolution performed by the drum of the first winch 8 connected to umbilical cable 10, enabling to determine the deployed length of umbilical cable 10.

Further, and in the same way, the deployed length of sling 11 is also known, and the control and command means drive the two winches 8, 9 so that the winding of umbilical cable 10 and of sling 11 is driven in order for them to substantially have the same deployed lengths, so that the two cables 10, 11 never touch. On the other hand, the control and command means drive the winding of sling 11 around the second winch 9 so that the tension of sling 11, measured by the corresponding traction sensor 16, is still smaller than or equal to a determined value stored in the memory space of the control and command means, when tethered balloon 2 is in flight phase. Thereby, the force exerted by sling 11 on the tethered balloon is sufficiently low to avoid for the nose 17 of balloon 2 to point down towards the ground. In other words, the traction force of sling 11 is lower than the buoyancy at any point of tethered balloon 2.

During the first step of the method, the control and command means drive the concurrent winding of umbilical cable 10 and of the connecting portion 13 of sling 11 around the drums of the two winches 8, 9, by simultaneously actuating said winches 8, 9, to avoid for umbilical cable 10 and sling 11 to touch and to entangle. However, as long as connecting portion 12 winds around the considered threshold 9, the traction force of sling 11 must remain lower than the above-mentioned threshold value. Tethered balloon 2 progressively comes down, which corresponds to the area II shown in FIG. 2.

Advantageously, if the traction force measured on umbilical cable 10 exceeds a second threshold value recorded into the memory space of the control and command means, then the latter drive the simultaneous stopping of the two winches 8, 9, to avoid deteriorating winches 8, 9 and/or aerostat 2, for example in case of significant wind gusts.

When tethered balloon 2 arrives in the area I shown in FIG. 2, the connecting portion 12 of sling 11 is totally wound around the drum of second winch 9 and the latter starts the winding of the mooring portion 13 of sling 11. The altitude of balloon 2 is then lower than 100 meters, and preferably lower than 30 or 40 meters.

At this stage, sling 11 is capable of withstanding the traction stress exerted by tethered balloon 2, and the control and command means drive winches 8, 9 so that the mooring portion 12 of sling 11 is stretched in the same way as umbilical cable 10. This provides a double advantage: not only is tethered balloon 2 aligned with the longitudinal axis X of boom 5, but also is the weathervane effect generated by the tapered shape of balloon 2 controlled.

The winding of cables 10, 11 carries on until tethered balloon 2 comes into contact with cradle 7. As soon as the tension of umbilical cable 10 exceeds a determined value, the control and command means stop winches 8, 9 and command the displacement of first winch 8 towards the rotation axis Y of boom 5, as shown in the right-hand drawing of FIG. 2. This displacement, combined with the final winding of winch 9, results in pressing the nose 17 of balloon 2 against the front crown 23 of vertical telescopic arm 22.

Finally, second winch 9 stretches the mooring portion 12 of sling 11 up to a determined tension value, after which the control and command means stop second winch 9. The ground staff may, if need be but not compulsorily, install the last mooring lines, without being concerned by the stability of balloon 2 on cradle 7.

Device 1 for releasing, maintaining in flight, and recovering tethered balloon 2 thus operates automatically and only requires the intervention of qualified staff once tethered balloon 2 has been secured on cradle 7, to install the last mooring lines reinforcing the mooring of tethered balloon 2 to cradle 7.

1. A device for automatically releasing, maintaining in flight, and recovering a tethered aerostat, comprising:
a platform comprising a fixed part provided to be placed on the ground, a rotatably mobile part which extends along a longitudinal axis and which is connected to the fixed part by rotary drive means, a recovery device called cradle secured to the mobile part and provided to receive an aerostat, and at least first and second cable winding devices called first and second winches;
control and command means configured to drive the rotary drive means and the first and second winches;
a first cable called umbilical cable connected to the first winch and having an end provided to be secured to the aerostat, the umbilical cable being adapted to withstanding the tension exerted by the aerostat, and
a second cable called sling divided into at least a mooring portion adapted to withstanding the tension exerted by the aerostat and having an end provided to be secured to the aerostat, and a connecting portion connected to the second winch, which connecting portion has a linear mass smaller than or equal to seven grams per meter and a length greater than that of the mooring portion.

2. The device according to claim 1, wherein the rotary drive means are motorized and driven via the control and command means.

3. The device according to claim 2, wherein the rotary drive means comprise an electric motor secured to the fixed part of the platform, at least one mobile pinion adapted to being driven by the motor and a crown secured to the mobile part of the platform and cooperating with the pinion, the pinion/crown assembly being arranged to allow a free rotation of the mobile part of the platform with respect to its fixed part.

4. The device according to claim 1, wherein the first winch comprises at least one drum arranged at a distance from the rotation axis of the mobile part of the platform.

5. The device according to claim 4, wherein the first winch comprise at least one deflection pulley arranged on the longitudinal axis of the mobile part of the platform, which deflection pulley is mobile along the longitudinal axis of said mobile part.

6. The device according to claim 2, wherein the rotary drive means comprise at least one means for assisting the rotation of the mobile part of the platform, which assistance means comprise at least one torque sensor connected to the control and command means and configured to detect the torque exerted by the umbilical cable against said sensor and to start said motor of the rotary drive means as soon as the detected torque exceeds a determined threshold value.

7. The device according to claim 1, wherein the device comprises two traction sensors connected to the control and command means and configured to measure the tractions respectively of the umbilical cable and of the mooring portion of the sling.

8. The device according to claim 1, wherein the umbilical cable and the mooring portion of the sling have a resistance to traction greater than or equal to 11.5 tons.

9. A system for automatically releasing, maintaining in flight, and recovering a tethered aerostat comprising:
an aerostat;
a platform comprising a fixed part provided to be placed on the ground, a rotatably mobile part connected to the fixed part by rotary drive means, a recovery device called cradle secured to the mobile part and provided to receive the aerostat, and at least first and second cable winding devices called first and second winches;
control and command means configured to drive the rotary drive means and the first and second winches;
a first cable called umbilical cable connected to the first winch and having an end secured to the aerostat, the umbilical cable being adapted to withstanding the tension exerted by the aerostat, and
a second cable called sling divided into at least a mooring portion adapted to withstanding the tension exerted by the aerostat and having an end secured to the aerostat, the respective ends of the umbilical cable and of the portion of the sling being aligned along an axis of the tethered aerostat, and a connecting portion connected to the second winch, which connecting portion has a linear mass smaller than or equal to seven grams per meter and a length greater than that of the mooring portion.

10. The system according to claim 9, wherein the sling is secured to the nose of the aerostat, which aerostat has a tapered shape.

11. The system according to claim 9, wherein the system comprises two traction sensors configured to measure the tractions respectively of the umbilical cable and of the mooring portion of the sling.
